(19) United States
(12) Patent Application Publication
(10) Pub. No.: US 2026/0205960 A1
(43) Pub. Date: Jul. 16, 2026

(54) POWER ALLOCATION FOR JOINT COMMUNICATION AND SENSING

(71) Applicant: Telefonaktiebolaget LM Ericsson (publ), Stockholm (SE)

(72) Inventors: Gabor FODOR, Hässelby (SE); Muhammad Ali KAZMI, Reston, VA (US)

(21) Appl. No.: 19/135,254

(22) PCT Filed: Dec. 12, 2022
(86) PCT No.: PCT/SE2022/051170

§ 371 Date: Jun. 3, 2025

(51) Int. Cl. H04W 52/36; H04W 52/28

(52) U.S. Cl. CPC H04W 52/365; H04W 52/28

(57) ABSTRACT

A method, network node and user equipment (UE) for power allocation for joint communication and sensing are disclosed. According to one aspect, a method in a UE includes determining a sensing power headroom (SPHR) for a sensing signal. The method also includes determining a power headroom for communication signals based at least in part on the SPHR. The method further includes transmitting an indication of the SPHR and the power headroom for communication signals to the network node.

### TECHNICAL FIELD

The present disclosure relates to wireless communications, and in particular, to power allocation for joint communication and sensing (JCAS).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD) such as user equipment (UE), as well as communication between network nodes and between UEs. The 3GPP is also developing standards for Sixth Generation (6G) wireless communication networks.

### Sensing

Radio-based detection, ranging (radar) and radio communications share some common characteristics. These functions exploit similar electromagnetic phenomena and have mechanisms to extract information from signals carried by electromagnetic waves. However, there are significant differences in their operational requirements. Recently, the 3GPP has started studying use cases in which communication systems and communication signals are also used as basic means for radar sensing. In a future 3GPP architecture, monostatic, bi-static and multi-static sensing are theoretically possible, as illustrated in FIG. 1.

FIG. 1 illustrates different radar settings that may be deployed using cellular base stations (network nodes) and user equipment (UE) devices. Typically, the goal is to detect and localize a passive (non-connected) object of interest.

In FIG. 1, item (a) monostatic sensing refers to the setting, for which the transmit sensing antenna array, denoted by TX-s, is co-located at the same physical node as the receiver sensing antenna array, denoted by RX-s. Note that monostatic sensing is possible using the Tx/Rx antennas at a UE as well.

In FIG. 1, item (b) bi-static setting corresponds to the case where the transmit sensing array antennas TX-s are located at a different node than the receiver sensing antennas RX-s. The TX-s and RX-s may be at a base station (BS) (hereafter referred to a network node) and/or a UE.

FIG. 1 item (c) shows the multi-static case, for which several TX-s and several RX-s are present and they are all located at different nodes (network nodes/UEs).

### UE Power Headroom Reporting (PHR)

The UE power headroom report (PHR) is used to report the power headroom currently available in the UE. In 4G and 5G systems, the (relative) PHR is encoded in a given number of bits (6), with a reporting range from −23 dB to +40 dB in steps of 1 dB as follows:
Positive values indicate the difference (or ratio) between the maximum UE transmit power and current UE transmit power; and
Negative values indicate the difference between the maximum UE transmit power and the calculated UE transmit power. The UE transmit power is calculated assuming the UE were to transmit according to the current scheduling grant with allocated hybrid automatic repeat request (HARQ) configuration.

The PHR may be configured either for a periodic report or when the downlink path loss changes by a specific amount. The PHR is a useful item of information to, for example, the network node scheduler, that uses the PHR as an input to determine the number of physical resource blocks (PRB) for the physical uplink shared channel (PUSCH) of the UE.

### Extended Power Headroom Reporting (EPHR)

The extended power is specified to support carrier aggregation already in LTE 3GPP Technical Release 10 (3GPP Rel-10).

Using the extended PHR, in the case of carrier aggregation, the UE reports the power headroom of each component carrier independently. The PHRs provide the serving network node with information about the difference between the UE maximum power and the estimated transmit power on PUSCH, or the transmit power on PUSCH and physical uplink control channel (PUCCH) on the primary carrier.

There are two types of PHRs to support the simultaneous transmission of the PUSCH and PUCCH. Type-1 power headroom is used to report the PUSCH transmit power, while Type-2 power headroom is used when reporting PUSCH and PUCCH transmit powers. The LTE/NR specifications specify the order in which the power headroom corresponding to the primary cell (PCell) and secondary cells (SCell) are reported (in the extended power headroom medium access control (MAC) control element (CE)).

### SUMMARY

Some embodiments advantageously provide methods, network nodes and wireless device for power allocation for joint communication and sensing.

When UEs are engaged in bi-static or mono-static sensing as shown in FIG. 1(a) and FIG. 1(b) the problem of allocating proper transmit power levels for sensing and communication arises. For example, the UE may use different frequency resource blocks or different spatial beams to transmit the sensing signal while transmitting a communication signal.

Although the extended EPHR mechanism allows the UE to report different power headroom for the primary and secondary carriers, they do not provide the network node with information that is needed to control the UE power for sensing purposes.

This lack of information at the network node is a problem since the UE must conserve its total available power. The lack of information may prevent the network node's efforts to minimize interference to neighboring cells when sending the sensing signal, while attempting to achieve proper signal to noise ratio (SNR) for the received radar signals at the radar receivers in the bi-static or mono-static cases.

In some embodiments, the UE is configured to report a power headroom, possibly on each carrier, specifically for radar purposes. The UE may indicate in its legacy PHR or EPHR that the power headroom report applies to both communication and sensing signal transmission. In some embodiments, the UE may also create a separate PHR for transmitting the sensing signal, in which case, it may indicate to the network node that the legacy PHR and EPHR apply only for the communication signals and that there is a separate PHR for sensing (referred to as SPHR).

The UE may also be configured by the network node or based on a pre-defined rule, to transmit the SPHR for the sensing signal based on one or more criteria. For example, the UE may be required to transmit the SPHR if the SPHR is below a certain threshold and/or if both SPHR and PHR (for communication signal) are above their respective thresholds. This mechanism may reduce signaling overheads.

When the UE supports the PC5 interface and sidelink (SL) communication, the UE may indicate in a SL-SPHR the power headroom for transmitting radar signals on the PC5 interface. This is useful when the radar receivers are also UEs in a bi-static or mono-static case.

The UE may also indicate a preferred priority for the communication and sensing signals in different serving cells e.g., PCell, PSCell (if dual connectivity is used) and SCells. The network node may then use the SPHR, SL-SPHR and Priority indications to determine the transmit power for the communication and radar signals transmitted by the UE. The network node may also inform the intended receiving UE, for analyzing the received sensing signal and setting detection threshold values.

In some embodiments, a new power headroom reporting mechanism, which reports the power headroom for sensing is provided. This additional information, together with a priority indication for the sensing and communication signals on the PCell and SCells, enables the serving network node (and possibly other network nodes) to properly set the UE transmit power for sensing and communications.

Advantages of some embodiments include the ability to make power level settings for both communication, and sensing purposes, while reusing the main structure of the UE power control mechanism for communication purposes only.

In some embodiments, both the sensing UE and the network node use similar control parameters to control the values of the sensing UE open loop power control mechanism as are used in LTE and NR to control the transmit power for PUSCH and PUCCH. Some embodiments provide the network node with the necessary information to set the PO open loop operating point (target SNR) for the UE, and determine the scheduled bandwidth, while the UE may report its headroom available for sensing and communications purposes.

Advantages of some embodiments may include support of sensing when carrier aggregation is used (similar to the usage of EPHR in LTE/NR) and the UE uses power control for sensing in primary and secondary cells.

Advantages of some embodiments may include enabling the UE to transmit a sensing signal on the PC5 (sidelink) interface.

Advantages of some embodiments may include enabling the UE to set the proper transmit power level when the UE engages in bi-static or multi-static sensing when the UE is the transmitter node, and the sensing signal is sent over the Uu or the PC5 interfaces. In these situations, some embodiments are configured to (1) allocate sufficient power for detection at the sensing UE, (2) set sufficient power for communication on the uplink (UL) signal (e.g. PUSCH, PUCCH, sounding reference signal (SRS), etc.) or PC5 for communication purposes, (3) while taking into account the UE power constraints on different carriers and as a whole and (4) while avoid high interference to other UEs by the sensing signal.

According to one aspect, a method in a first user equipment, UE, configured to communicate with a network node is provided. The method includes: determining a sensing power headroom report, SPHR, for a sensing signal; determining a power headroom for communication signals based at least in part on the SPHR; and transmitting an indication of the SPHR and the power headroom for communication signals to the network node.

According to this aspect, in some embodiments, the method includes receiving from the network node a configuration of a sensing signal resource pattern that includes at least one of a start time of the sensing signal resource pattern and a periodicity of the sensing signal resource pattern. In some embodiments, transmitting the SPHR to the network node is performed based at least in part on a comparison between the SPHR and a threshold. In some embodiments, the threshold is based at least in part on a type of serving cell used for joint communication and sensing operation. In some embodiments, the method includes transmitting to the network node an indication of a first priority of transmission between sensing signals and communication signals in different serving cells. In some embodiments, the method includes transmitting to the network node an indication of a second priority among the sensing signal and the communication signals. In some embodiments, the method includes setting a power for transmitting the sensing signal based at least in part on the SPHR, the power setting being configured by the network node. In some embodiments, the method includes transmitting the SPHR to a second UE. In some embodiments, the method includes transmitting the sensing signal to the network node. In some embodiments, the method includes transmitting the sensing signal to a second UE. In some embodiments, the method includes receiving a maximum transmit power setting for transmitting the sensing signal to a second UE. In some embodiments, the power headroom for communication signals and the SPHR are based at least in part on at least one of a power class, a number of uplink signals used by the first UE for transmission, a number of available uplink signals for transmission, bandwidth of available uplink signals used by the first UE, bandwidth of available uplink signals, time resources used by the first UE for uplink signals and time resources for which the uplink signals are available for transmission. In some embodiments, an uplink signal includes at least one of: an uplink physical signal, an uplink physical channel and an uplink resource block. In some embodiments, a time resource includes at least one of: a symbol, a sub-slot, a mini-slot, a slot, a subframe, frame, an interleaving time and a transmission time interval.

According to another aspect, a first user equipment, UE, configured to communicate with a network node is provided. The first UE includes processing circuitry configured to: determine a sensing power headroom report, SPHR, for a sensing signal; and determine a power headroom for communication signals based at least in part on the SPHR. The first UE also includes a radio interface in communication with the processing circuitry and configured to transmit an indication of the SPHR and the power headroom for communication signals to the network node.

According to this aspect, in some embodiments, the processing circuitry is further configured to receive from the network node a configuration of a sensing signal resource pattern that includes at least one of a start time of the sensing signal resource pattern and a periodicity of the sensing signal resource pattern. In some embodiments, transmitting the SPHR to the network node is performed based at least in part on a comparison between the SPHR and a threshold. In some embodiments, the threshold is based at least in part on a type of serving cell used for joint communication and sensing operation. In some embodiments, the processing circuitry is further configured to transmit to the network node an indication of a first priority of transmission between sensing signals and communication signals in different serving cells. In some embodiments, the processing circuitry is further configured to transmit to the network node an indication of a second priority among the sensing signal and a communication signal. In some embodiments, the processing circuitry is further configured to set a power for transmitting the sensing signal based at least in part on the SPHR, the power setting being configured by the network node. In some embodiments, the processing circuitry is further configured to transmit the SPHR to a second UE. In some embodiments, the processing circuitry is further configured to transmit the sensing signal to the network node. In some embodiments, the radio interface is further configured to transmit the sensing signal to a second UE. In some embodiments, the radio interface is further configured to receive a maximum transmit power setting for transmitting the sensing signal to a second UE. In some embodiments, the power headroom for communication signals and the SPHR are based at least in part on at least one of a power class, a number of uplink signals used by the first UE for transmission, a number of available uplink signals for transmission, bandwidth of available uplink signals used by the first UE, bandwidth of available uplink signals, time resources used by the first UE for uplink signals and time resources for which the uplink signals are available for transmission.

According to yet another aspect, a method in a network node configured to communicate with a plurality of user equipment, UEs, is provided. The method includes: receiving from the first UE an indication of a sensing power headroom, SPHR, of the UE; performing at least one operational task based at least in part on the received indication of the SPHR; and determining a configuration of physical resource blocks for a transmission by the first UE of a sensing signal, the configuration of physical resource blocks being based at least in part on the SPHR.

According to this aspect, in some embodiments, the method includes configuring the first UE to be a sensing transmitter in a sensing session. In some embodiments, the method includes determining a configuration of uplink signals for transmitting a sensing signal by the first UE, the configuration of the uplink signals being based at least in part on the SPHR. In some embodiments, an uplink signal includes at least one of: an uplink physical signal, an uplink physical channel and an uplink resource block. In some embodiments, the method includes configuring the first UE with a sensing signal resource pattern that includes at least one of a start time of the sensing signal resource pattern and a periodicity of the sensing signal resource pattern. In some embodiments, the method includes configuring the first UE to transmit the SPHR when the SPHR is below a threshold. In some embodiments, the indication of the SPHR includes an indication of a first priority for sensing signals among different serving cells of the network node. In some embodiments, the indication of the SPHR includes an indication of a second priority between the sensing signal and a communication signal. In some embodiments, the method includes allocating physical resource blocks among communication signals and sensing signals according to at least one of the first and second priorities. In some embodiments, the method includes configuring the first UE with a power setting for transmitting the sensing signal based at least in part on the SPHR. In some embodiments, determining the configuration of physical resource blocks is based at least in part on a minimum power density over the physical resource blocks. In some embodiments, the method includes configuring at least one UE of the plurality of UEs to receive the sensing signal from the first UE. In some embodiments, the method includes scheduling uplink transmissions for the first UE to avoid conflict between resources allocated for communication signals and resources allocated for sensing signals.

According to another aspect, a network node configured to communicate with a plurality of user equipment (UEs) is provided. The network node includes a radio interface configured to receive from the first UE an indication of a sensing power headroom, SPHR, of the first UE. The network node includes processing circuitry in communication with the radio interface and configured to: perform at least one operational task based at least in part on the received indication of the SPHR; and determine a configuration of physical resource blocks for a transmission by the first UE of a sensing signal, the configuration of physical resource blocks being based at least in part on the SPHR.

According to this aspect, in some embodiments, the processing circuitry is configured to configure the UE to be a sensing transmitter in a sensing session. In some embodiments, the processing circuitry is further configured to determine a configuration of uplink signals for transmitting a sensing signal by the first UE, the configuration of the uplink signals being based at least in part on the SPHR. In some embodiments, an uplink signal includes at least one of: an uplink physical signal, an uplink physical channel and an uplink resource block. In some embodiments, the processing circuitry is further configured to configure the first UE with a sensing signal resource pattern that includes at least one of a start time of the sensing signal resource pattern and a periodicity of the sensing signal resource pattern. In some embodiments, the processing circuitry is further configured to configure the first UE to transmit the SPHR when the SPHR is below a threshold. In some embodiments, the indication of the SPHR includes an indication of a first priority for sensing signals among different serving cells of the network node. In some embodiments, the indication of the SPHR includes an indication of a second priority between the sensing signal and a communication signal. In some embodiments, the processing circuitry is further configured to allocate physical resource blocks among communication signals and sensing signals according to at least one of the first and second priorities. In some embodiments, the processing circuitry is further configured to configure the first UE with a power setting for transmitting the sensing signal based at least in part on the SPHR. In some embodiments, determining the configuration of physical resource blocks is based at least in part on a minimum power density over the physical resource blocks. In some embodiments, the processing circuitry is further configured to configure at least one UE of the plurality of UEs to receive the sensing signal from the first UE. In some embodiments, the processing circuitry is further configured to schedule uplink transmissions for the first UE to avoid conflict between resources allocated for communication signals and resources allocated for sensing signals.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates examples of monostatic, bi-static and multi-static sensing;

FIG. 2 is a schematic diagram of an example network architecture illustrating a communication system connected via an intermediate network to a host computer according to the principles in the present disclosure;

FIG. 3 is a block diagram of a host computer communicating via a network node with a user equipment over an at least partially wireless connection according to some embodiments of the present disclosure;

FIG. 4 is a flowchart illustrating example methods implemented in a communication system including a host computer, a network node and a user equipment for executing a client application at a user equipment according to some embodiments of the present disclosure;

FIG. 5 is a flowchart illustrating example methods implemented in a communication system including a host computer, a network node and a user equipment for receiving user data at a user equipment according to some embodiments of the present disclosure;

FIG. 6 is a flowchart illustrating example methods implemented in a communication system including a host computer, a network node and a user equipment for receiving user data from the user equipment at a host computer according to some embodiments of the present disclosure;

FIG. 7 is a flowchart illustrating example methods implemented in a communication system including a host computer, a network node and a user equipment for receiving user data at a host computer according to some embodiments of the present disclosure;

FIG. 8 is a flowchart of an example process in a network node for power allocation for joint communication and sensing;

FIG. 9 is a flowchart of an example process in a user equipment for power allocation for joint communication and sensing;

FIG. 10 is an example scenario for sensing with a UE acting as a transmitter of a communication signal and a sensing signal; and

FIG. 11 is an example of a signaling sequence to configure a UE with power levels for communications and sensing.

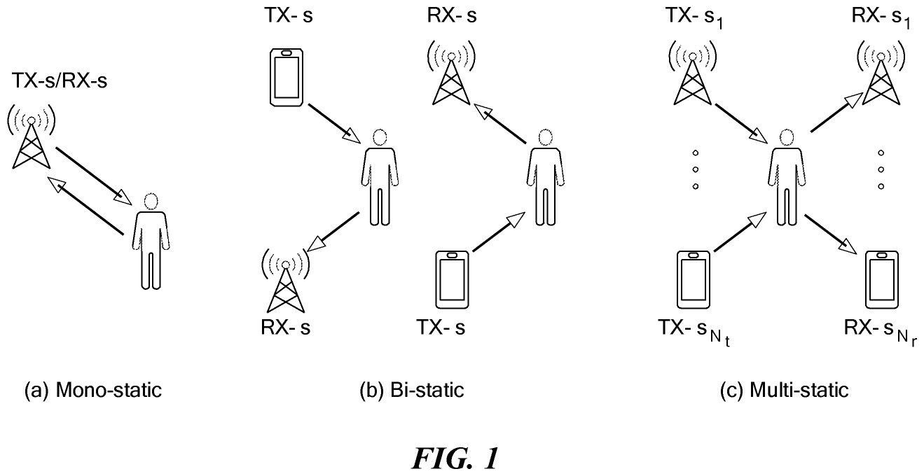

### DETAILED DESCRIPTION

Before describing in detail example embodiments, it is noted that the embodiments reside primarily in combinations of apparatus components and processing steps related to power allocation for joint communication and sensing. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (network node), radio base station, base transceiver station (BTS), base station controller (BSC), radio network controller (RNC), g Node B (gNB), evolved Node B (eNB or eNodeB), Node B, multi-standard radio (MSR) radio node such as MSR network node, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a user equipment (UE)

In some embodiments, the non-limiting term user equipment (UE) or wireless device (WD) are used interchangeably. The UE herein may be any type of user equipment capable of communicating with a network node or another UE over radio signals, such as user equipment (UE). The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a user equipment or a network node may be distributed over a plurality of wireless devices and/or network nodes. In other words, it is contemplated that the functions of the network node and user equipment described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide power allocation for joint communication and sensing.

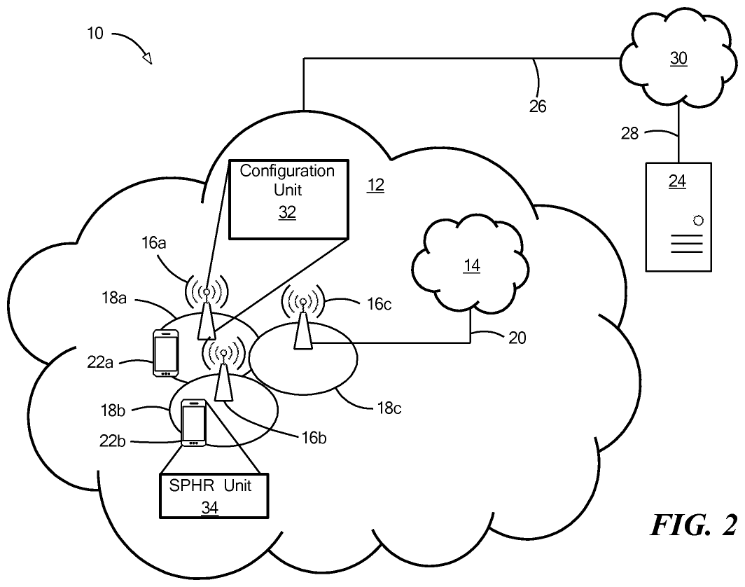

Returning now to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as wireless devices 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 may be in simultaneous communication and/or configured to separately communicate with more than one network node 16 and more than one type of network node 16. For example, a UE 22 may have dual connectivity with a network node 16 that supports LTE and the same or a different network node 16 that supports NR. As an example, UE 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected UEs 22a, 22b and the host computer 24. The connectivity may be described as an over-the-top (OTT) connection. The host computer 24 and the connected UEs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected UE 22a. Similarly, the network node 16 need not be aware of the future routing of an outgoing uplink communication originating from the UE 22a towards the host computer 24.

A network node 16 is configured to include a configuration unit 32 which is configured to determine a configuration of physical resource blocks for a transmission by the first UE 22 of a sensing signal, the configuration of physical resource blocks being based at least in part on an SPHR. A user equipment 22 is configured to include an SPHR unit 34 which is configured to determine a power headroom for communication signals based at least in part on the SPHR.

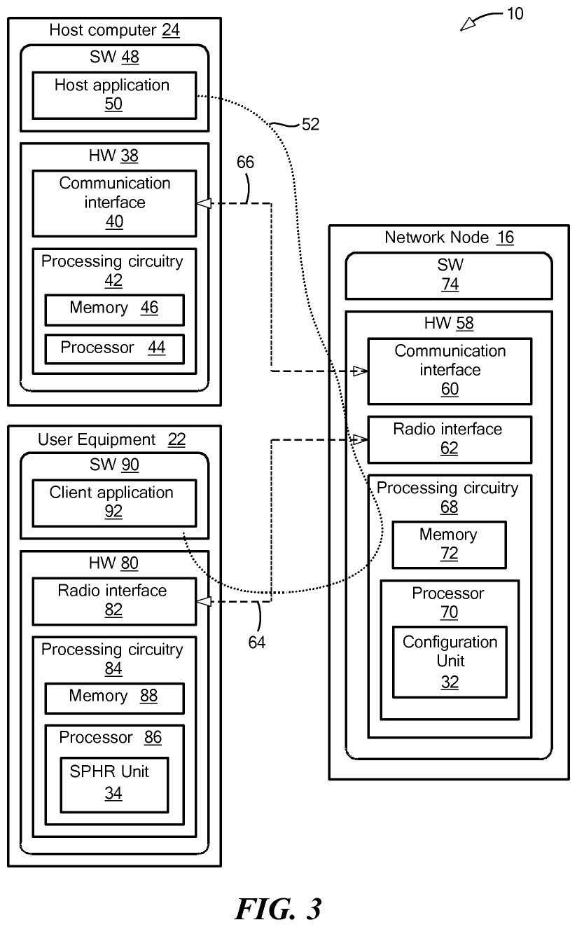

Example implementations, in accordance with an embodiment, of the UE 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a UE 22 connecting via an OTT connection 52 terminating at the UE 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the user equipment 22.

The communication system 10 further includes a network node 16 provided in a communication system 10 and including hardware 58 enabling it to communicate with the host computer 24 and with the UE 22. The hardware 58 may include a communication interface 60 for setting up and maintaining a wired or wireless connection with an interface of a different communication device of the communication system 10, as well as a radio interface 62 for setting up and maintaining at least a wireless connection 64 with a UE 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which is configured to determine a configuration of physical resource blocks for a transmission by the first UE 22 of a sensing signal, the configuration of physical resource blocks being based at least in part on an SPHR.

The communication system 10 further includes the UE 22 already referred to. The UE 22 may have hardware 80 that may include a radio interface 82 configured to set up and maintain a wireless connection 64 with a network node 16 serving a coverage area 18 in which the UE 22 is currently located. The radio interface 82 may be formed as or may include, for example, one or more RF transmitters, one or more RF receivers, and/or one or more RF transceivers.

The hardware 80 of the UE 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 90, which is stored in, for example, memory 88 at the UE 22, or stored in external memory (e.g., database, storage array, network storage device, etc.) accessible by the UE 22. The software 90 may be executable by the processing circuitry 84. The software 90 may include a client application 92. The client application 92 may be operable to provide a service to a human or non-human user via the UE 22, with the support of the host computer 24. In the host computer 24, an executing host application 50 may communicate with the executing client application 92 via the OTT connection 52 terminating at the UE 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by UE 22. The processor 86 corresponds to one or more processors 86 for performing UE 22 functions described herein. The UE 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to UE 22. For example, the processing circuitry 84 of the user equipment 22 may include an SPHR unit 34 which is configured to determine a power headroom for communication signals based at least in part on the SPHR.

In some embodiments, the inner workings of the network node 16, UE 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the user equipment 22 via the network node 16, without explicit reference to any intermediary devices and the precise routing of messages via these devices. Network infrastructure may determine the routing, which it may be configured to hide from the UE 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the UE 22 and the network node 16 is in accordance with the teachings of the embodiments described throughout this disclosure. One or more of the various embodiments improve the performance of OTT services provided to the UE 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and UE 22, in response to variations in the measurement results. The measurement procedure and/or the network functionality for reconfiguring the OTT connection 52 may be implemented in the software 48 of the host computer 24 or in the software 90 of the UE 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary UE signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the UE 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the UE 22, and/or preparing/terminating/maintaining/supporting/ending in receipt of a transmission from the UE 22.

In some embodiments, the host computer 24 includes processing circuitry 42 and a communication interface 40 that is configured to a communication interface 40 configured to receive user data originating from a transmission from a UE 22 to a network node 16. In some embodiments, the UE 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as configuration unit 32, and SPHR unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

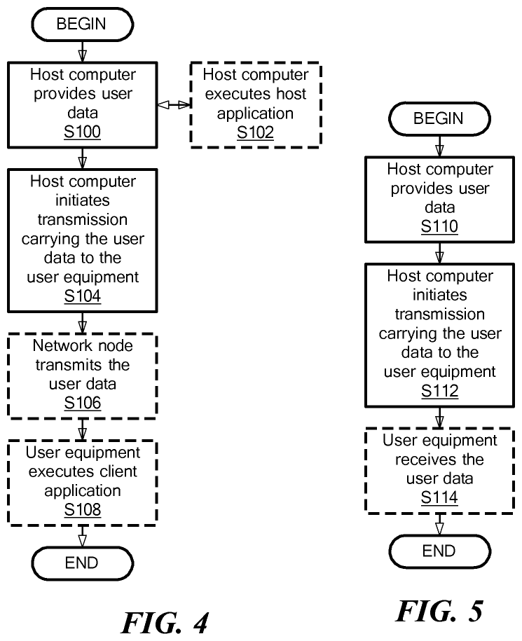

FIG. 4 is a flowchart illustrating an example method implemented in a communication system, such as, for example, the communication system of FIGS. 2 and 3, in accordance with one embodiment. The communication system may include a host computer 24, a network node 16 and a UE 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the UE 22 (Block S104). In an optional third step, the network node 16 transmits to the UE 22 the user data which was carried in the transmission that the host computer 24 initiated, in accordance with the teachings of the embodiments described throughout this disclosure (Block S106). In an optional fourth step, the UE 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a UE 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the UE 22 (Block S112). The transmission may pass via the network node 16, in accordance with the teachings of the embodiments described throughout this disclosure. In an optional third step, the UE 22 receives the user data carried in the transmission (Block S114).

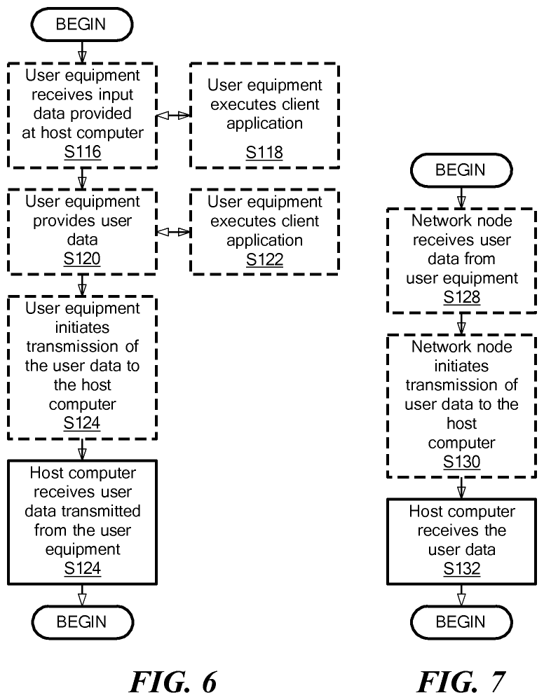

FIG. 6 is a flowchart illustrating an example method implemented in a communication system, such as, for example, the communication system of FIG. 2, in accordance with one embodiment. The communication system may include a host computer 24, a network node 16 and a UE 22, which may be those described with reference to FIGS. 2 and 3. In an optional first step of the method, the UE 22 receives input data provided by the host computer 24 (Block S116). In an optional substep of the first step, the UE 22 executes the client application 92, which provides the user data in reaction to the received input data provided by the host computer 24 (Block S118). Additionally or alternatively, in an optional second step, the UE 22 provides user data (Block S120). In an optional substep of the second step, the UE provides the user data by executing a client application, such as, for example, client application 92 (Block S122). In providing the user data, the executed client application 92 may further consider user input received from the user. Regardless of the specific manner in which the user data was provided, the UE 22 may initiate, in an optional third substep, transmission of the user data to the host computer 24 (Block S124). In a fourth step of the method, the host computer 24 receives the user data transmitted from the UE 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a UE 22, which may be those described with reference to FIGS. 2 and 3. In an optional first step of the method, in accordance with the teachings of the embodiments described throughout this disclosure, the network node 16 receives user data from the UE 22 (Block S128). In an optional second step, the network node 16 initiates transmission of the received user data to the host computer 24 (Block S130). In a third step, the host computer 24 receives the user data carried in the transmission initiated by the network node 16 (Block S132).

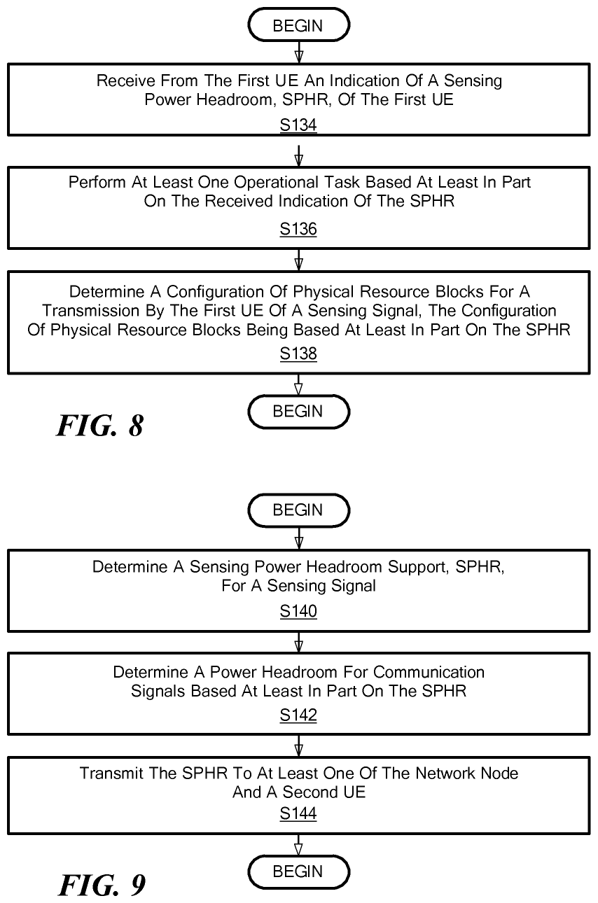

FIG. 8 is a flowchart of an example process in a network node 16 for power allocation for joint communication and sensing. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to receive from the first UE 22 an indication of a sensing power headroom, SPHR, of the UE 22 (Block S134). The process includes performing at least one operational task based at least in part on the received indication of the SPHR (Block S136). The process also includes determining a configuration of physical resource blocks for a transmission by the first UE 22 of a sensing signal, the configuration of physical resource blocks being based at least in part on the SPHR (Block S138).

In some embodiments, the method includes configuring the first UE 22 to be a sensing transmitter in a sensing session. In some embodiments, the method includes determining a configuration of uplink signals for transmitting a sensing signal by the first UE 22, the configuration of the uplink signals being based at least in part on the SPHR. In some embodiments, an uplink signal includes at least one of: an uplink physical signal, an uplink physical channel and an uplink resource block. In some embodiments, the method includes configuring the first UE 22 with a sensing signal resource pattern that includes at least one of a start time of the sensing signal resource pattern and a periodicity of the sensing signal resource pattern. In some embodiments, the method includes configuring the first UE 22 to transmit the SPHR when the SPHR is below a threshold. In some embodiments, the indication of the SPHR includes an indication of a first priority for sensing signals among different serving cells of the network node 16. In some embodiments, the indication of the SPHR includes an indication of a second priority between the sensing signal and a communication signal. In some embodiments, the method includes allocating physical resource blocks among communication signals and sensing signals according to at least one of the first and second priorities. In some embodiments, the method includes configuring the first UE 22 with a power setting for transmitting the sensing signal based at least in part on the SPHR. In some embodiments, determining the configuration of physical resource blocks is based at least in part on a minimum power density over the physical resource blocks. In some embodiments, the method includes configuring at least one UE 22 of the plurality of UEs to receive the sensing signal from the first UE 22. In some embodiments, the method includes scheduling uplink transmissions for the first UE 22 to avoid conflict between resources allocated for communication signals and resources allocated for sensing signals.

FIG. 9 is a flowchart of an example process in a user equipment 22 according to some embodiments disclosed herein. One or more blocks described herein may be performed by one or more elements of user equipment 22 such as by one or more of processing circuitry 84 (including the SPHR unit 34), processor 86, radio interface 82 and/or communication interface 60. Wireless device 22 such as via processing circuitry 84 and/or processor 86 and/or radio interface 82 is configured to determine a sensing power headroom, SPHR, report for a sensing signal (Block S140). The process includes determining a power headroom for communication signals based at least in part on the SPHR (Block S142). The process also includes transmitting an indication of the SPHR and the power headroom for communication signals to the network node 16 (Block S144).

In some embodiments, the method includes receiving from the network node 16 a configuration of a sensing signal resource pattern that includes at least one of a start time of the sensing signal resource pattern and a periodicity of the sensing signal resource pattern. In some embodiments, transmitting the SPHR to the network node 16 is performed based at least in part on a comparison between the SPHR and a threshold. In some embodiments, the threshold is based at least in part on a type of serving cell used for joint communication and sensing operation. In some embodiments, the method includes transmitting to the network node 16 an indication of a first priority of transmission between sensing signals and communication signals in different serving cells. In some embodiments, the method includes transmitting to the network node 16 an indication of a second priority among the sensing signal and a communication signal. In some embodiments, the method includes setting a power for transmitting the sensing signal based at least in part on the SPHR, the power setting being configured by the network node 16. In some embodiments, the method includes transmitting the SPHR to a second UE 22. In some embodiments, the method includes transmitting the sensing signal to the network node 16. In some embodiments, the method includes transmitting the sensing signal to a second UE 22. In some embodiments, the method includes receiving a maximum transmit power setting for transmitting the sensing signal to a second UE 22. In some embodiments, the power headroom for communication signals and the SPHR are based at least in part on at least one of a power class, a number of uplink signals used by the first UE 22 for transmission, a number of available uplink signals for transmission, bandwidth of available uplink signals used by the first UE 22, bandwidth of available uplink signals, time resources used by the first UE 22 for uplink signals and time resources for which the uplink signals are available for transmission. In some embodiments, an uplink signal includes at least one of: an uplink physical signal, an uplink physical channel and an uplink resource block. In some embodiments, a time resource includes at least one of: a symbol, a sub-slot, a mini-slot, a slot, a subframe, frame, an interleaving time and a transmission time interval.

Having described the general process flow of arrangements of the disclosure and having provided examples of hardware and software arrangements for implementing the processes and functions of the disclosure, the sections below provide details and examples of arrangements for power allocation for joint communication and sensing.

In some embodiments described herein, the term bandwidth part (BWP) is used. To enable UE power saving and avoid interference, the UE can be configured by the higher layer with a set of bandwidth parts (BWPs) for signal receptions (e.g. physical downlink control channel (PDCCH), physical downlink shared channel (PDSCH), etc.) by the UE (downlink (DL) BWP set, e.g., up to 4 DL BWPs) and a set of BWPs for signal transmissions (e.g., physical uplink control channel (PUCCH), physical uplink shared channel (PUSCH)) by the UE (UL BWP set, e.g., up to 4 uplink (UL) BWPs) in a serving cell, e.g., special cell (SpCell) (e.g., primary cell (Pcell), primary and secondary cell (PSCell)), secondary cell (Scell), etc. Each BWP can be associated with multiple parameters. Examples of such parameters are: BW, (e.g. number of time-frequency resources, (e.g., resource blocks such as 25 physical resource blocks (PRBs), etc.), location of BWP in frequency (e.g., starting resource block (RB) index of BWP or center frequency, etc.), subcarrier spacing (SCS), cyclic prefix (CP) length, any other baseband parameter (e.g. multiple input multiple output (MIMO) layer, receivers, transmitters, HARQ related parameters, etc.), etc.

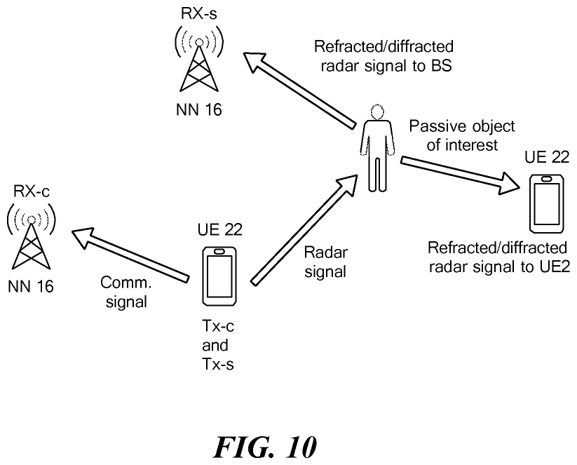

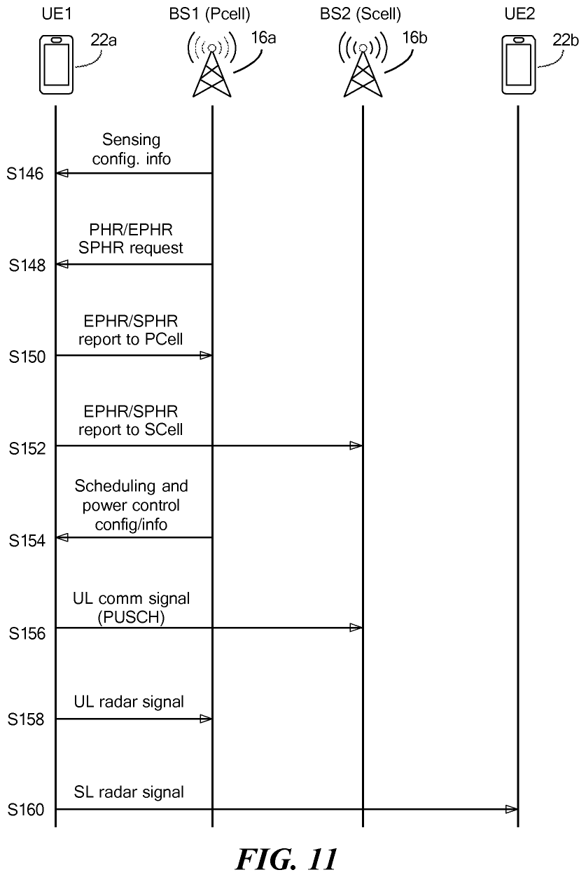

FIG. 10 shows an example of a scenario, in which UE1 22a acts as both Tx-c and Tx-s (that is both as a transmitter of a communication signal and a sensing signal), that is UE1 22a is engaged in both UL communication and UL sensing. FIG. 11 is an example of a signaling sequence that enables the serving network node (BS1 16a) to configure UE1 22a so that it has desired power levels for communication and sensing. Specifically, in some embodiments, one or more of the following steps may be performed:

The serving network node (BS1 16a) signals to UE1 22a that UE1 22a is designated as a sensing transmitter in an upcoming sensing session (S146). This message may include characteristics of the sensing session and the sensing signal that UE1 22a should transmit e.g., sensing signal resource pattern comprising of starting reference time (e.g., system frame number, SFN) when the pattern starts, periodicity of the sensing signal resources, time-frequency resources for operating sensing signal, duration over which the pattern is valid, etc. For example, UE1 22a may be configured as both a transmitter (Tx) and a receiver (Rx), or only as a Tx. The configuration may also indicate the maximum transmit power for sensing, to limit the UE1 22a transmit power for both the uplink and the sidelink (if the sidelink is used by UE1 22a). BS1 16a may explicitly trigger a PHR/EPHR/SPHR by signaling a corresponding request message (S148). In this request message, the BS1 16a may also configure periodicity or other triggering conditions, such as measured signal strength (e.g., path loss, RSRP, etc.) from BS1 16a, network node-k in the SCell, based on the value of PHR/EPHR/SPHR etc. For example, the UE 22 may report SPHR if the SPHR is small (e.g., below certain threshold) or the UE 22 may report SPHR if both SPHR and PHR (for communication signal) are small (e.g., below their respective thresholds). The thresholds may be pre-defined or configured by the BS1 16a. BS1 16a may also indicate the serving cell (e.g., PCell, PSCell or SCell) to which this SPHR should be sent by UE1 22a, etc.

Thus, in some embodiments, transmitting the SPHR to the network node 16 is performed based at least in part on whether the SPHR falls below a first threshold. In some embodiments, transmitting the SPHR to the network node 16 is performed based at least in part on whether the SPHR increased above a second threshold.

UE1 22a may send the EPHR/SPHR to the specified BSs, including its PCell, PSCell (e.g., in dual connectivity) (S150) and SCells (S152). UE1 22a may take into account its power class, the number of physical channels or resources (e.g., PRBs) it is currently using for communication or has been using for communication in the previous scheduling intervals (grants), and the bandwidth (number of PRBs) that it may be scheduled on.

When the network node (e.g., BS1 16a) serving the PCell receives the EPHR and SPHR messages from UE1 22a, it determines the number of PRBs that the UE 22 may use for communication (e.g., PUSCH, PUCCH, SRS, etc.) and sensing (radar) signal transmission. BS1 16a takes into account the power headroom reported for both communication and sensing when determining the number of resource blocks, using a minimum power density over the NR network node, which may be different for communications and sensing. BS1 16a notifies UE1 22a about the PRBs that should be used for PUSCH and sensing (S154).

Based on this information, UE1 22a may execute open loop fractional path loss compensation power settings for both the UL communication signal (S156) (e.g., PUSCH, PUCCH, SRS etc.) and the sensing signals (S158) and (S160). Note that the UE 22 may be scheduled by BS1 16a to transmit on Uu or on the PC5 (if PC5 is configured and supported by UE1 22a). In the case of transmitting the sensing signal on PC5, BS1 16a may optionally configure, several UEs for the reception of the sensing signal from UE1 22a.

If any of the PHR and SPHR are above a certain threshold (H1), then the UE 22 may indicate the priority levels of the communication signal and sensing signal. H1 may be pre-defined or configured by BS1 16a. The priority level may further depend on the type of serving cell used for joint communication and sensing (JCAS) operation e.g., PCell, PSCell or Scell, etc. BS1 16a may use the indicated priority to decide whether to allow the UE 22 to transmit the communication signal or the sensing signal e.g., when they are frequency division multiplexed (FDM) with respect to each other or close to each other in time (e.g., in the same time slot). For example, the UE 22 may indicate that the priority level of the transmission of the sensing signal is higher than the priority of transmission of the communication signal. In this case, BS1 16a may not schedule the UE 22 with the transmission of the communication signal in resources which are frequency division multiplexed (FDM) (or close in time) with respect to resources used for transmission of sensing signals. In another example, the UE 22 may indicate that the priority level of the transmission of the sensing signal is higher than the priority of transmission of the communication signal in SCell(s) but not in SpCell (e.g., PCell or PSCell). For example, the UE 22 may indicate that the priority level of the transmission of the sensing signal is lower than the priority of transmission of the communication signal in in SpCell (e.g., PCell or PSCell).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| EPHR | Extended Power Headroom Report |
| JCAS | Joint communication and sensing |
| PCell | Primary Cell |
| PHR | Power Headroom Report |
| PSCell | Primary Secondary Cell |
| PUSCH | Physical Uplink Shared Channel |
| RSRP | Reference Signal Received Power |
| SPHR | Sensing PHR |
| SCell | Secondary Cell |
| SFN | System Frame Number |
| SL | Sidelink |
| SNR | Signal to Noise Ratio |
| SpCell | Special Cell |
| UE | User Equipment |
| UL | Uplink |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a first user equipment, UE (22), configured to communicate with a network node, the method comprising:
determining a sensing power headroom report, SPHR, for a sensing signal;
determining a power headroom for communication signals based at least in part on the SPHR; and
transmitting an indication of the SPHR and the power headroom for communication signals to the network node.

2. The method of claim 1, further comprising receiving from the network node a configuration of a sensing signal resource pattern that includes at least one of a start time of the sensing signal resource pattern and a periodicity of the sensing signal resource pattern.

3.-52. (canceled)

53. The method of claim 1, wherein transmitting the SPHR to the network node is performed based at least in part on a comparison between the SPHR and a threshold, and wherein the threshold is based at least in part on a type of serving cell used for joint communication and sensing operation.

54. The method of claim 1, further comprising transmitting to the network node one or both of:
an indication of a first priority of transmission between sensing signals and communication signals in different serving cells; and
an indication of a second priority among the sensing signal and the communication signals.

55. The method of claim 1, further comprising setting a power for transmitting the sensing signal based at least in part on the SPHR, the power setting being configured by the network node.

56. The method of claim 1, further comprising transmitting one or both:
the SPHR to a second UE; and
the sensing signal to one or both of the network node and a second UE.

57. The method of claim 1, wherein the power headroom for communication signals and the SPHR are based at least in part on at least one of a power class, a number of uplink signals used by the first UE for transmission, a number of available uplink signals for transmission, bandwidth of available uplink signals used by the first UE, bandwidth of available uplink signals, bandwidth of a bandwidth part (BWP) containing the available uplink signals used by the first UE, bandwidth of a BWP containing the available uplink signals, time resources used by the first UE for uplink signals and time resources for which the uplink signals are available for transmission.

58. A first user equipment, UE, configured to communicate with a network node, the first UE comprising:
processing circuitry configured to:
determine a sensing power headroom report, SPHR, for a sensing signal; and
determine a power headroom for communication signals based at least in part on the SPHR; and
a radio interface in communication with the processing circuitry and configured to transmit an indication of the SPHR and the power headroom for communication signals to the network node.

59. The first UE of claim 58, wherein the radio interface is further configured to receive from the network node a configuration of a sensing signal resource pattern that includes at least one of a start time of the sensing signal resource pattern and a periodicity of the sensing signal resource pattern.

60. A method in a network node configured to communicate with a plurality of user equipment, UEs, the method comprising:
receiving from a first UE an indication of a sensing power headroom report, SPHR, and a power headroom for communication signals of the first UE;
performing at least one operational task based at least in part on the received indication of the SPHR; and
determining a configuration of physical resource blocks for a transmission by the first UE of a sensing signal, the configuration of physical resource blocks being based at least in part on the SPHR.

61. The method of claim 60, further comprising configuring the first UE to be a sensing transmitter in a sensing session.

62. The method of claim 60, further comprising determining a configuration of uplink signals for transmitting a sensing signal by the first UE, the configuration of the uplink signals being based at least in part on the SPHR.

63. The method of claim 60, further comprising configuring the first UE with a sensing signal resource pattern that includes at least one of a start time of the sensing signal resource pattern and a periodicity of the sensing signal resource pattern.

64. The method of claim 60, further comprising configuring the first UE to transmit the SPHR when the SPHR is below a threshold.

65. The method of claim 60, wherein the indication of the SPHR includes one or both of:
an indication of a first priority for sensing signals among different serving cells of the network node; and
an indication of a second priority between the sensing signal and a communication signal.

66. The method of claim 60, further comprising allocating physical resource blocks among communication signals and sensing signals according to at least one of the first and second priorities.

67. The method of claim 60, further comprising configuring the first UE with a power setting for transmitting the sensing signal based at least in part on the SPHR.

68. The method of claim 60, wherein determining the configuration of physical resource blocks is based at least in part on a minimum power density over the physical resource blocks.

69. The method of claim 60, further comprising configuring at least one UE of the plurality of UEs to receive the sensing signal from the first UE.

70. The method of claim 60, further comprising scheduling uplink transmissions for the first UE to avoid conflict between resources allocated for communication signals and resources allocated for sensing signals.
